(19) United States
(12) Patent Application Publication
(10) Pub. No.: US 2005/0064822 A1
(43) Pub. Date: Mar. 24, 2005

(54) Audio accessory optimization system

(76) Inventors: Robert J. Higgins, Plantation, FL (US); James M. Carsello, Weston, FL (US); Ellis A. Pinder, Davie, FL (US); Cheah Heng Tan, Villa Emas (MY)

Correspondence Address: Barbara R. Doutre;Motorola, Inc., Law Department, 8000 West Sunrise Boulevard, Fort Lauderdale, FL, 33322, US

(21) Appl. No.: 10/669,033

(22) Filed: Sep. 23, 2003

(51) Int. Cl. H04K 1/00

(52) U.S. Cl. 455/90.2; 705/65; 711/115; 455/550.1

(57) ABSTRACT

An audio accessory optimization system (100) includes an audio accessory (104) that couples to a radio (102), the audio accessory including a memory (112) containing a plurality of descriptors (116, 118, 120) that provide information to enable radio optimization of the accessory audio performance.

### CROSS REFERENCE TO RELATED APPLICATIONS

This application is related to pending U.S. application Docket No. CM06393J by Pinder, et al. entitled “Interface System for an Accessory and a Communication Device” and U.S. application Docket No. CM06386J by Ellis A. Pinder, entitled “Method And Apparatus To Self-Configure Device Identification,” both filed concurrently herewith, and assigned to Motorola, Inc.

### TECHNICAL FIELD

This invention relates in general to accessories, and more particularly to audio accessories for portable communication devices.

### BACKGROUND

Many portable radio products are equipped with an internal microphone and speaker. In such products, the audio performance is optimized using these internal audio components. Optional audio accessories can also be used with the radio, and although designers attempt to make the audio accessory performance similar to the radio's audio performance, it is usually only a coarse match. Because of this, the audio accessories do not typically realize the most desirable audio response that the accessory transducers (microphone and speaker) may be capable of producing.

Today, radios are designed to provide an analog audio interface to an attached audio accessory. The dividing line between what is placed in the radio and what is in the accessory is such that modification of the audio performance from the accessory side of the system is considered difficult and expensive. Thus, the accessory audio response is largely determined by the accessory's acoustic response and the radio's audio processing that is normally designed for the radio's internal acoustic elements. Since the acoustic response of the accessory and the radio differ because of use of different elements and housings, the accessory never operates at the audio quality level of which it is capable.

Variations of audio characteristics between accessory and radio (and accessory to accessory) are very detectable by the user. For example, a remote speaker microphone (RSM) with omnidirectional microphones has a substantially different voice response compared to an RSM with the same housing but having a noise-canceling microphone element.

Newer radios are being equipped with the capability to communicate with an embedded memory for identification (ID) of accessories and batteries. An embedded memory is a device or device subset that can be placed in a desired location (the accessory in this case) and whose data contents can be read by a remote processor. An example of an embedded memory is a 1-Wire® bus EEPROM available from Dallas Semiconductor. A 1-Wire® bus is a single wire power and data communications bus system that has a single bus master, typically a microcontroller, and one or more slaves. To provide this ID information in accessories, an embedded memory is included within the accessory. Today, the embedded memory is used only to identify the accessory model; the radio software must store the operating configuration and characteristics for all accessory models planned for use with the radio. While some radios are flash-upgradeable and can thus be programmed to understand and support future accessories, it may not be convenient to upgrade such a radio. Furthermore, many radios are designed to be non customer-upgradeable, which puts a tremendous burden on the radio software to anticipate all future accessories. Accordingly, there is a need for an improved audio optimization system that provides predictable uniform behavior from accessory to accessory, and there is a need to allow implementation of such a system that is substantially portable to both current and future radios.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a block diagram of an audio accessory optimization system in accordance with the present invention; and

FIG. 2 is a radio having an audio accessory coupled thereto operating in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. As mentioned in the Background, newer radios are being equipped with the capability to communicate with an embedded memory for identification (ID) of accessories and batteries. To provide this ID information in accessories, an embedded memory device (EMD) such as a 1-Wire® bus EEPROM, is included within the accessory containing a 4-byte “Accessory Identifier” for the accessory. Today, this 4-byte Accessory Identifier is used to look up the barest accessory characteristics (primarily what interface to turn on) in a table within the radio software. Table 1 shows the memory organization hierarchy for a prior art accessory EMD.

TABLE 1

| Memory Offset (Hex) | Contents |
|---|---|
| 0x0000 | 4-byte Accessory ID String |
| 0x0004 | blank space (don't care) |
| 0x0005 | blank space (don't care) |
| . . . | . . . |
| -EOF- | blank space (don't care) |

In accordance with the present invention, there is provided herein an audio optimization scheme in which an audio accessory contains an embedded memory having in addition to the ID (for backward compatibility), Accessory Configuration Data (ACD). The ACD contains data descriptors to provide parameterized information about the accessory's audio characteristics, capabilities, and suggested audio equalizations such that a host radio can provide the best possible audio processing to optimize audio performance with the accessory. All information needed to optimally operate the accessory exists within the accessory itself (in the embedded memory) and is accessible by the host radio once the accessory is attached. The parameterized information in the ACD offers an improvement over known audio accessories, because the information is readily parsable and understood by the radio, even future radio models. This is in contrast to audio accessories that merely contain an Accessory Identifier.

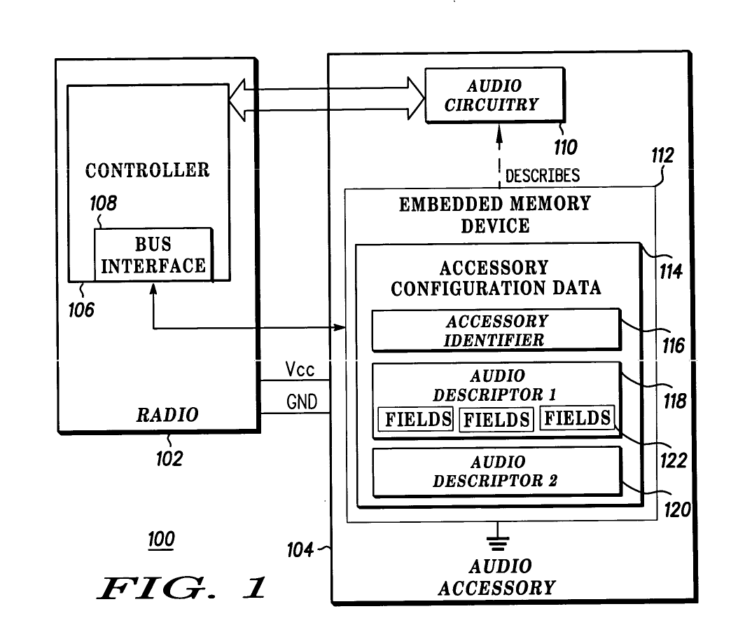

Referring now to FIG. 1, there is shown a block diagram of an audio accessory optimization system 100 in accordance with the present invention. System 100 includes a radio 102 having a remote audio accessory 104 coupled thereto. Radio 102 can be a portable or mobile radio. Remote audio accessory 104 can be a remote speaker microphone, a headset, a vehicular adapter, or other externally coupled audio device. Radio 102 includes a controller 106 and a bus interface 108, preferably a 1-Wire® bus interface. Although the 1-Wire® bus is preferred for its simplicity, those skilled in the art will recognize parallel and other serial bus memories may be substituted. The audio accessory 104 includes audio circuitry 110, which may include a speaker and/or microphone, or other audio device. In accordance with the present invention, an embedded memory device (EMD) 112, such as a 1-Wire® EEPROM, is included within the accessory 104 containing Accessory Configuration Data 114. Accessory Configuration Data 114 contains Accessory Identifier 116 and at least one Audio Descriptor such as 118 and 120. In accordance with the present invention, audio descriptors 118 and 120 embody information about the audio capability or acoustic performance of the accessory including interface parameters, performance models, suggested equalizer filters, and operational limits that enable optimization of the performance of audio accessory 104. The audio descriptors 118 and 120 can contain arbitrary amounts of data that follows some established format to allow parsing by the radio. Specific audio parameters are stored in fields 122, with each descriptor having at least one field. In a given accessory all audio parameters could be stored in a single descriptor, all parameters could be stored in separate descriptors, or parameters can be grouped in descriptors logically. Logical grouping, the preferred approach, facilitates re-use because like parameters tend to be all present or all absent in a given accessory.

As an example of logical grouping of descriptor fields, consider two microphones with stored audio parameters formed in accordance with the present invention. One of the two microphones, a Remote Speaker Microphone (RSM), additionally contains a speaker. Audio parameters associated with the microphone element are grouped in fields 122 of Audio Descriptor #1 118. This descriptor is present in both microphones. Audio parameters associated with the speaker are grouped in fields (not shown in figure) of Audio Descriptor #2 120. This descriptor is present only in the Remote Speaker Microphone because only it has a speaker. By associating specific audio components or capabilities with matching descriptors, the descriptors themselves can be re-used in various combinations in other audio accessories. This approach simplifies descriptor construction and radio parsing.

The descriptors themselves are stored as part of the Accessory Configuration Data, which can be viewed as a data structure. Those skilled in the art will recognize that there are many ways to organize and access the audio descriptors with the Accessory Configuration Data. Such organization may even involve a hierarchy of descriptors. To ensure maximum flexibility in the support of future accessories, a radio must be able to detect multiple audio descriptors of arbitrary length, and it must bypass descriptors that it does not recognize. Descriptors may evolve over time with additional fields added to the end of the descriptor.

The audio optimization system 100 can also provide security to the enclosed data. Encryption or digital signature techniques may be utilized on a per-descriptor basis or on the Accessory Configuration Data as a whole. Such security techniques ensure inferior imitation accessories cannot be used with the radio.

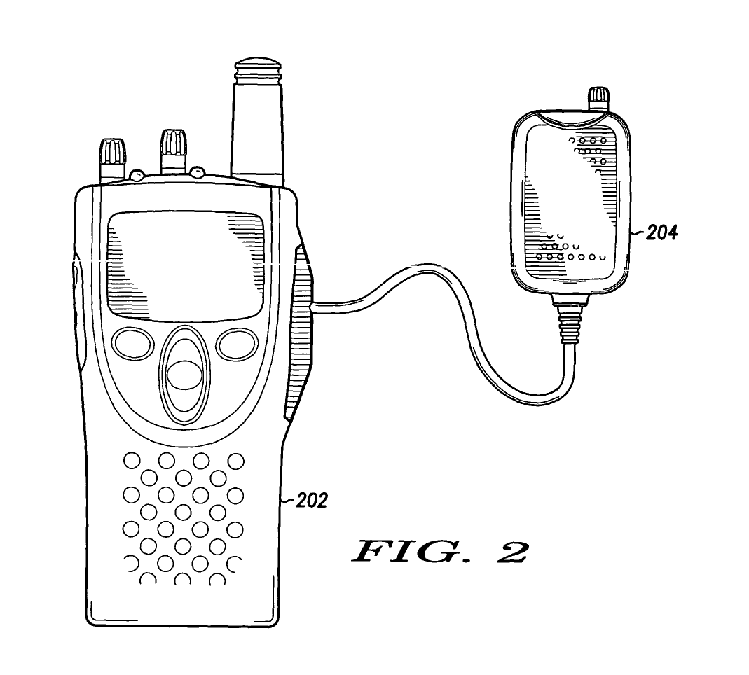

FIG. 2 shows a radio 202 having an audio accessory 204, such as a remote speaker microphone, coupled thereto formed in accordance with the present invention. Radio 202 and audio accessory 204 operate in accordance with the audio optimization system described in FIG. 1. The description above shows how information can be encoded into an embedded memory which, in accordance with the present invention, becomes a part of the audio accessory 204. The audio accessory optimization system 100 of the present invention thus expands the embedded memory to include within its data contents, information needed for the host radio 202 to optimally utilize the audio accessory 204.

ACD content in a predetermined format, which consists of sets of audio and acoustic parameters, is conveyed from the accessory 204 to the radio 202 and can include, but is not limited to, audio interface type, number of audio modes and signaling configuration, duplex capability, receive audio parameters, and transmit audio parameters. An example of ACD content information is given below:

1. Audio Interface type (Analog, Digital, Mixed, None)—Allows the radio to turn off the audio power amplifier if it is not needed and to provide digital audio to a prescribed port when it is needed.

2. Number of audio modes and signaling configuration. For example if an RSM has a jack for a plug-in earphone, but still uses the microphone in the RSM, the system can be set up with two audio modes having different parameters supplied for each of the modes.

3. Duplex capability (continuous full duplex, signaled full duplex, simplex). Some accessories, such as a headset will be capable of full duplex (simultaneous talk and listen) and others such as the RSM will not. The radio may receive full duplex audio and if a simplex accessory is attached may have to operate in a “speakerphone” mode. To know what to do, the radio must know the accessory's audio capability.

4. Receive Audio Parameters (loudspeaker in accessory typically)

a. power amplifier (PA) mode or line mode. This would describe if the analog control knob, or in line mode where the output voltage gain is fixed.

b. Transducer load impedance (in ohms). By specifying this, it is possible to use different loudspeaker impedances in the external audio accessory. It gives the radio the capability to limit its output to that which will not create distortion due to current clipping in lower impedance speakers. It also gives the radio a means to set appropriate limits to protect audio output transistors.

c. Maximum output level to prevent transducer damage (Volts RMS for example). This is the level, that if exceeded, could cause damage to the accessory. A good example might be the use of an earphone or earbud. These devices may not be capable of using a greater than (>)10 Vpp audio signal (that many radios can produce) without damage.

d. Effective sound pressure level (SPL) at standard frequency, level, and position. This will be used to gauge how loud the accessory is providing audio. The radio may change the equalization for low loudness levels as compared to very loud loudness levels. This can also be used to help limit exposure to very high SPL levels and prevent damage to the user's ear.

e. Cone envelope parameters—These allow the radio to model cone displacement given that the source is a complicated waveform. This modeling could be used to predict cone displacement saturation and the onset of rapid rise in distortion, and provides the radio with a means to estimate when distortion mitigation processing would be of value (compression for example).

f. Equalization filters which yield a flat response in standard listening position.

The embedded memory specification may provide all of ii)-iv) below and let the radio choose to utilize the filter that it can provide at lowest current drain.
i) none required—the speaker output itself is already flat (may be the case for line audio for example).
ii) standard form IIR (Infinite Impulse Response) filter with coefficients. This is a specification of the coefficients for a DSP filter which the radio should apply to the audio (before driving the audio PA) to realize a flat response in the accessory output.
iii) standard form FIR (Finite Impulse Response) filter with coefficients. This is a specification of the coefficients for another DSP filter which the radio should apply to the audio (before driving the audio PA) to realize a flat response in the accessory output.
iv) standard form semi-octave band equalizer coefficients. This is a specification of another filter which the radio should apply to the audio (before driving the audio PA) to realize a flat response in the accessory output.

5. Transmit Audio Parameters (microphone in accessory typically)

a. minimum microphone bias voltage. Most analog audio accessories have a bias voltage provided on the microphone line and the radio capacitively couples the input audio. The microphone bias voltage for a portable radio may be 4V where a mobile radio might use 8V.

b. maximum microphone bias voltage. The microphone bias voltage must be limited to prevent damage to the internal microphone elements. Most microphone elements will withstand voltages below 10V.

c. microphone electrical model parameters. These will describe in a standard form the difference between voltage source microphones and current source microphones. Voltage source microphones (low impedance) will have little change in sensitivity as a function of the radio's choice of microphone bias resistor. In current source microphones (typical active electret microphone elements, the sensitivity is directly proportional to the microphone bias resistor choice. These modeling parameters will give the radio a means to estimate the microphone sensitivity knowing its (the radio's) microphone bias implementation.

d. microphone sensitivity in standard position, frequency, load. This information is used to calibrate the received level in terms of absolute SPL and allows the radio to appropriately set the front end gain to the analog input for proper voice level. Secondarily, this information is used to assess the absolute noise level in which the user is immersed. This absolute noise level can then be used to trigger changes to the microphone path's equalization and/or the speaker equalization. These changes must occur based on SPL and not just on microphone output voltage that could change from accessory to accessory.

e. microphone acoustic model. It is desirable to know how the microphone behaves as a function of position with respect to the sound source (lips). In most cases, the frequency response will change as well as the sensitivity as the microphone is moved from its nominal position. Having model parameters for this can enable the radio to optimize voice pickup in varying situations.
i) Sensor type (omni, noise canceling). This is part of the model.
ii) Response variation with distance. Variation with distance may include frequency response change.

f. Equalization filters. Like the receive audio case, the transmit audio can be improved with proper equalization. In quiet environments, one might prefer a voice based equalization while in environments filled with very loud noise, a flat noise equalization may be more desirable. The embedded memory specification may provide all of i)-vii) below and let the radio choose which to use.
i) None required.

In a line input case, this might be the desirable equalizer choice.
ii) Standard form IIR filter with coefficients for flat source correction. Source in this case probably means the voice.
iii) Standard form FIR filter with coefficients for flat source correction.
iv) Standard form semi-octave band equalizer coefficients for flat source correction.
v) Standard form IIR filter with coefficients for flat noise correction. Equalization for flat background noise may be preferable in high noise environments.
vi) Standard form FIR filter with coefficients for flat noise correction.
vii) Standard form semi-octave band equalizer coefficients for flat noise correction.

Utilizing the content information such as described above, the radio 202 is able to adjust its configuration so that the accessory 204 can operate with optimized audio quality.

The audio accessory optimization system of the present invention provides several advantages over existing technology. Coding the information into the accessory embedded memory allows the radio software to be built with parsing rules, but the software need not anticipate all product configurations. A radio built in a given year will be able to use some or all of the capabilities of an accessory designed several years later. The use of security techniques within the audio descriptors prevents unauthorized operation of imitation accessories. The embedded memory data content framework is backward compatible which allows an accessory formed in accordance with the present invention to be retrofitted with existing radio products if desired.

Accordingly, there has been provided an audio optimization system in which an audio accessory contains an embedded memory having information describing its audio characteristics, capabilities, and suggested audio equalizations such that a host radio can provide the best possible audio source to optimize audio performance from the accessory and make all accessories behave in a uniform manner. The audio accessory optimization system of the present invention expands the embedded memory data content to include within memory, information needed for the host radio to optimally utilize the audio accessory. By expanding the memory data content to include a complete description of the accessory, readily parsable by host software, all information needed to optimally operate the accessory exists within the accessory itself and is accessible by the host radio once the accessory is attached. The addition of memory data content audio descriptors enables the system to improve accessory audio quality, simplify radio software, and provide multi-levels of functionality to the accessories. The digital signature of the descriptors of the present invention allows a further degree of security to be built into the accessory such that a customer or accessory competitor cannot readily change, duplicate, or re-use the embedded memory data content.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An audio accessory optimization system, comprising:
a radio; and
an audio accessory coupled to the radio, the audio accessory including an embedded memory, the embedded memory containing information to enable the radio to optimize the accessory audio performance.

2. The audio accessory optimization system of claim 1, wherein the radio is a portable radio.

3. The audio accessory optimization system of claim 1, wherein the radio is a mobile radio.

4. The audio accessory optimization system of claim 1, wherein the information contained in the embedded memory is organized in a hierarchical fashion.

5. The audio accessory optimization system of claim 1, wherein the information contained in the embedded memory is used to create an encrypted digital signature that is also stored in the embedded memory.

6. The audio accessory optimization system of claim 1, wherein the embedded memory uses a single wire bus data communications means.

7. The audio accessory optimization system of claim 6, wherein the single wire bus data communications means comprises a 1-Wire® bus.

8. An audio accessory optimization system, comprising:
an audio accessory having content information stored therein, the content information for conveying information pertaining to the accessory's audio characteristics, the accessory for coupling to one of a plurality of radios wherein each of the plurality of radios detects the content information and optimizes the audio of the accessory in response thereto.

9. The audio accessory optimization system of claim 8, wherein the content information includes at least one of: audio interface type, number of audio modes and signaling configuration, duplex capability, receive audio parameters, transmit audio parameters, and receiver to transmitter transducer coupling parameters.

10. The audio accessory optimization system of claim 9, wherein the receive audio parameters include at least one of: power amplifier mode, line mode, transducer load impedance, maximum output level, effective sound pressure level (SPL), cone envelope parameters, and equalization filters.

11. The audio accessory optimization system of claim 10, wherein the equalization filters comprise at least one of: a standard form 11R filter with coefficients, a standard form FIR filter with coefficients, a standard form semi-octave band equalizer coefficients.

12. The audio accessory optimization system of claim 10, wherein the transmit audio parameters includes at least one of: minimum microphone bias voltage, maximum microphone bias voltage, microphone electrical model parameters, microphone sensitivity, and microphone acoustic model, equalization filters.

13. The audio accessory optimization system of claim 12 wherein the microphone acoustic model includes at least one of: sensor type and response variation with distance.

14. The audio accessory optimization system of claim 12, wherein the equalization filters comprise at least one of: a standard form IIR filter with coefficients, a standard form FIR filter with coefficients, a standard form semi-octave band equalizer coefficients.

15. An audio accessory, comprising
audio optimization parameters stored in the audio accessory; and
the audio accessory for coupling to a variety of different radios, each radio having different audio characteristics, the audio accessory being automatically adjusted by each radio based on the audio parameters stored in the audio accessory.

16. The audio accessory of claim 15, wherein the audio accessory includes a memory device containing a plurality of descriptors that provide hierarchical information to enable radio optimization of the audio accessory audio performance.
